(19) United States
(12) Patent Application Publication
(10) Pub. No.: US 2018/0198177 A1
(43) Pub. Date: Jul. 12, 2018

(54) DEVICE FOR DETECTING BATTERY DEFORMATION BY MEANS OF SENSOR MODULE AND METHOD THEREFOR

(71) Applicant: SHENZHEN SBASE ELECTRONICS TECHNOLOGY CO., LTD., Guangdong (CN)

(72) Inventor: Zhangsheng CHEN, Guangdong (CN)

(73) Assignee: SHENZHEN SBASE ELECTRONICS TECHNOLOGY CO., LTD., Guangdong (CN)

(21) Appl. No.: 15/533,035

(22) PCT Filed: May 17, 2016
(86) PCT No.: PCT/CN2016/082386

§ 371 Date: Jun. 5, 2017

(51) Int. Cl. H01M 10/48; H01M 2/34; H02J 7/00

(52) U.S. Cl. CPC H01M 10/48; H02J 7/0068; H01M 2/34

(57) ABSTRACT

Disclosed is a device for detecting battery deformation by a sensor module and a method therefor, comprising a battery module, a circuit board, a fixed base groove, a sensor module and a battery chamber, wherein the former three parts are provided in the battery chamber; the sensor module which forms a protective system with the circuit board is provided in the fixed base groove and located on one side of the fixed base groove near the battery module; the battery module and the sensor module are electrically connected to the circuit board respectively. Once any abnormal deformation of overall or local morphology of the battery module reaches the pre-set threshold, the sensor in the sensor module will be triggered to send a trigger signal, so that the circuit board will stop charging and discharging of the battery module to avoid more serious consequences and protect the product and users' safety.

### BACKGROUND OF THE INVENTION

### Technical Field

The present invention relates to a battery deformation detector, and more particularly, to a device for detecting battery deformation by means of a sensor module and to a method for applying the device for detecting battery deformation by means of a sensor module.

### Description of Related Art

Currently, in the field of mobile energy storage applications, lithium batteries have gradually become an energy carrier of energy storage applications due to their small size, high energy density, long cycle life and memoryless effect, but because lithium battery is a kind of chemical and is subjected to the effects of chemical materials, manufacturing and production process, ambient temperature, physical damage, irregular use of charging and discharging, its cycle life and a variety of accidental operations, it may lead to changes in the internal chemical substances: for example, the generation of gas pressure leads to a certain morphological change in the battery which may result in performance degradation due to the physical and chemical damage of the battery; in this case, if users do not perceive the changes and continue to use the function of the battery to charge and discharge the battery for quite a long time, the battery will be found with irreversible damage in its morphology, such as a bulge, due to the further rise of internal pressure caused by the further reaction of chemical substances inside the battery. And when the pressure exceeds the extent to which the battery's protective skin or protective shell can withstand it, it may cause unintended consequences.

The conventional method of detecting battery deformation adopts a temperature sensor, but it just simply has the temperature probe fitted in a certain position of the battery, which not only limits the position and area for detecting the temperature of the battery, but also limits the basis for the battery's protective board to detect whether the battery is in an abnormal state by detecting whether the temperature of the battery or the battery pack exceeds the safety value. In case of the occurrence of physical and chemical damage in the battery, the temperature may not be extremely high and the bulging process may be slow and the temperature does not necessarily change significantly; in this case, the conventional temperature sensor is unable to detect the changes in the battery's morphology, such as a bulge, caused by physical and chemical damage. However, because the product's shell usually allows a certain degree of space buffer of thermal expansion for the battery, so that a slight bulge or abnormal local morphology of the battery or the local battery pack will not cause changes in the product's appearance and will not draw the user's attention, which increases the risk factor of the product gradually. In addition, the continued charging of a bulged battery is likely to cause fire or even the risk of explosion.

### BRIEF SUMMARY OF THE INVENTION

The technical problem to be solved by the present invention is that it is necessary to provide a device for detecting battery deformation by means of a sensor module which can instantly turn off the charging and discharging of a battery and a battery pack in case of any deformation of the battery or the battery pack so as to protect the product as well as the user's personal and property safety, and a method for applying the device for detecting battery deformation by means of a sensor module.

Therefore, the present invention provides a device for detecting battery deformation by means of a sensor module, comprising a battery module, a circuit board, a fixed base groove, a sensor module and a battery chamber, wherein the battery module, the circuit board and the fixed base groove are provided in the battery chamber, and the fixed base groove is provided in the battery chamber; the sensor module is provided in the fixed base groove and located on one side of the fixed base groove near the battery module; wherein the battery module and the sensor module are electrically connected to the circuit board respectively.

A further improvement of the present invention is that the fixed base groove is mounted in the battery chamber in the form of a separate module, or the fixed base groove is directly provided on the battery chamber.

A further improvement of the present invention is that the sensor module is located above the battery module.

A further improvement of the present invention is that the fixed base groove is a ditch-shaped or square groove.

A further improvement of the present invention is that the circuit board comprises an MCU.

A further improvement of the present invention is that one side of the battery module is fixedly provided on the fixed base groove and connected with the fixed base groove; the other side of the battery module is connected with the battery chamber.

A further improvement of the present invention is that the sensor module comprises horizontally-distributed and longitudinally-distributed dot matrix sensors.

The present invention also provides a method for detecting battery deformation by means of a sensor module, which is applied to a device for detecting battery deformation by means of a sensor module as described above and comprises the following steps:

Step S1: the circuit board conducts real-time detection until a trigger signal transmitted from at least one sensor in the sensor module is received;

Step S2: the circuit board sends a stop signal to the battery module to turn off the charging and discharging of the battery module;

Step S3: when the sensor module is reset, a reset signal will be sent to the circuit board;

Step S4: the circuit board sends a reset signal to the battery module to restore the charging and discharging of the battery module.

A further improvement of the present invention is that in Step S1, when the overall or local morphology of the battery module reaches an abnormality threshold, the battery module is determined to be abnormal in morphology, and the sensor module sends a trigger signal to the circuit board.

A further improvement of the present invention is that the abnormality threshold is set to X₀=h+X₁+X₂, wherein X₀ is an abnormality threshold of the overall or local morphology of the battery module, h is an overall height of the battery module, X₁ is a space buffer of thermal expansion generated in normal operation of the battery module, and X₂ is the squeeze key path or range required for triggering any of the sensors.

Compared with the prior art, the beneficial effects of the present invention are as below: the sensor module is provided in the battery chamber and forms a protective system together with the circuit board; in case of any abnormal deformation of the overall or local morphology of the battery module, the deformation value reaching or exceeding the pre-set abnormality threshold will trigger the sensor in the sensor module to send an interrupt signal, and the MCU on the circuit board which receives the trigger signal will turn off the charging and discharging operation of the battery module as well as other product functions of the battery module so as to avoid more serious consequences and protect the product itself and the user's personal and property safety.

### BRIEF DESCRIPTION OF THE SEVERAL VIEWS OF THE DRAWINGS

FIG. 1 is an overall structural diagram of the fixed base groove separately provided in one embodiment of the present invention;

FIG. 2 is an overall sectional view of the fixed base groove separately provided in one embodiment of the present invention;

FIG. 3 is a schematic diagram of the circuit in one embodiment of e present invention;

FIG. 4 is an overall structural diagram of the fixing base directly provided in the battery chamber according to one embodiment of the present invention;

FIG. 5 is a sectional view of the ditch-shaped fixed base groove which is directly provided in the battery chamber according to one embodiment of the present invention;

FIG. 6 is a sectional view of the square fixed base groove which is directly provided in the battery chamber according to one embodiment of the present invention; and

FIG. 7 is a work flow diagram of another embodiment of the present invention.

### DETAILED DESCRIPTION OF THE INVENTION

The preferred embodiment of the present invention is further detailed in combination with the drawings as follows.

### Embodiment 1

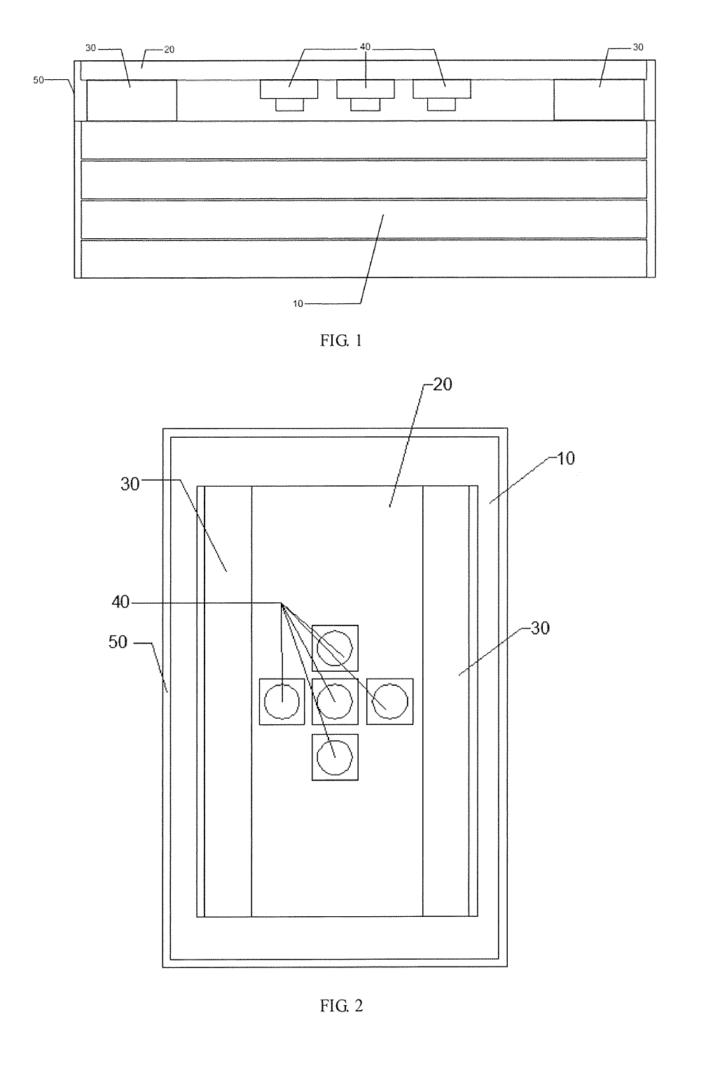

As shown in FIG. 1 to FIG. 6, this embodiment provides a device for detecting battery deformation by means of a sensor module, comprising a battery module 10, a circuit board 20, a fixed base groove 30, a sensor module 40 and a battery chamber 50, wherein the battery module 10, the circuit board 20 and the fixed base groove 30 are provided in the battery chamber 50, and the fixed base groove 30 is provided in the battery chamber 50; the sensor module 40 is provided in the fixed base groove 30 and located on one side of the fixed base groove 30 near the battery module 10; wherein the battery module 10 and the sensor module 40 are electrically connected to the circuit board 20 respectively.

The sensor module 40 is provided in the fixed base groove 30 and located on one side of the fixed base groove 30 near the battery module 10; preferably, the sensor module 40 is provided above the battery module 10, as shown in FIG. 1, the sensor module 40 is provided in the fixed base groove 30 and above the battery module 10; for example, the sensor module 40 may be separately formed as a module affixed to the battery module 10, and the battery module 10 and the sensor module 40 are electrically connected to the circuit board 20 respectively.

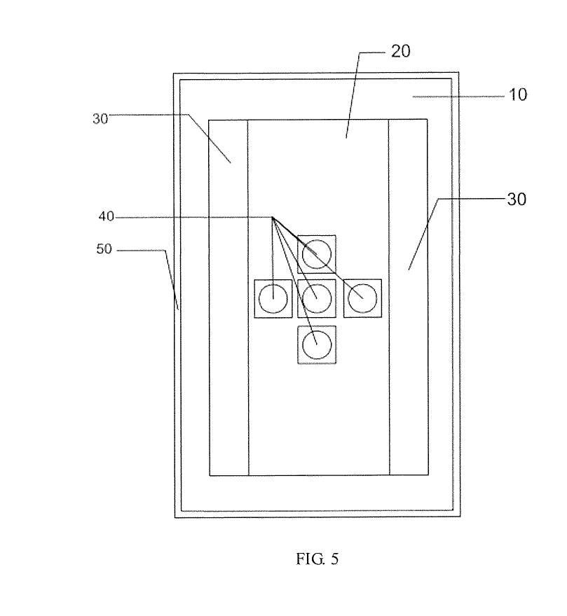

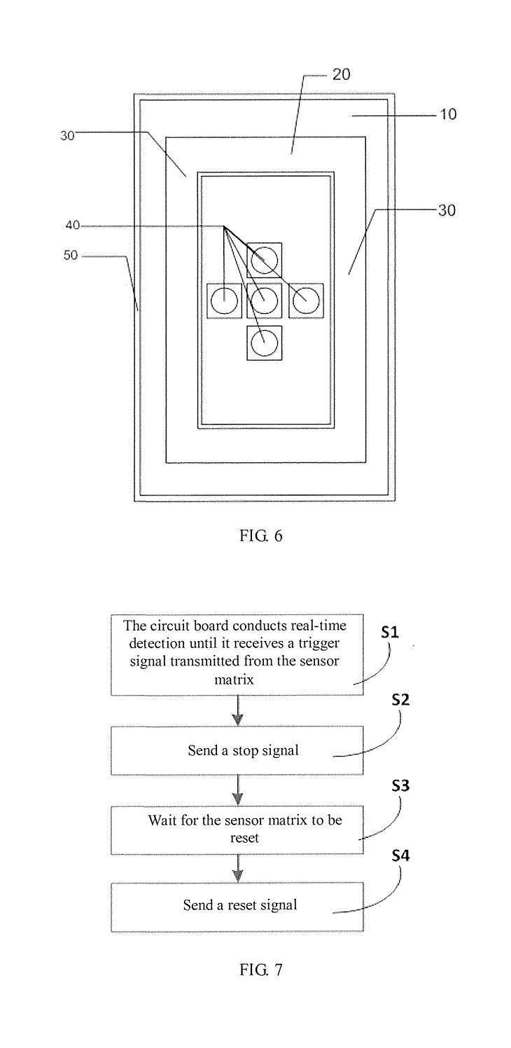

The circuit board 20 described in this embodiment is fixedly provided in the battery chamber 50; as shown in FIGS. 1 and 2, the fixed base groove 30 may be mounted in the battery chamber 50 in the form of a separate module, or as shown in FIGS. 4 to 6, the fixed base groove 30 is directly provided on the battery chamber 50. As shown in FIGS. 5 and 6, the fixed base groove may be a ditch-shaped or square groove, and the sensor module 40 may be provided in the fixed base groove 30; one side of the battery module 10 is fixedly provided on the fixed base groove 30 and tightly connected with the fixed base groove 30 without a slit; the other side of the battery module 10 is tightly connected with the battery chamber 50 without a slit; in this case the sensor module 40 faces the battery module 10, and the precision mechanical pressure sensor and/or the precision electronic sensor on the sensor module 40 is/are arranged in the longitudinal direction and the lateral direction toward the battery module 10. As shown in FIG. 2, the sensor module 40 comprises horizontally-distributed and longitudinally-distributed dot matrix sensors, and the number of sensors on the sensor module 40 can be set according to the characteristics of the product, such as one or more (more than one sensors can be formed into a dot matrix), as shown in FIG. 2; for a small product, the use of one sensor can achieve the purpose; the battery module 10 comprises a battery or a battery pack.

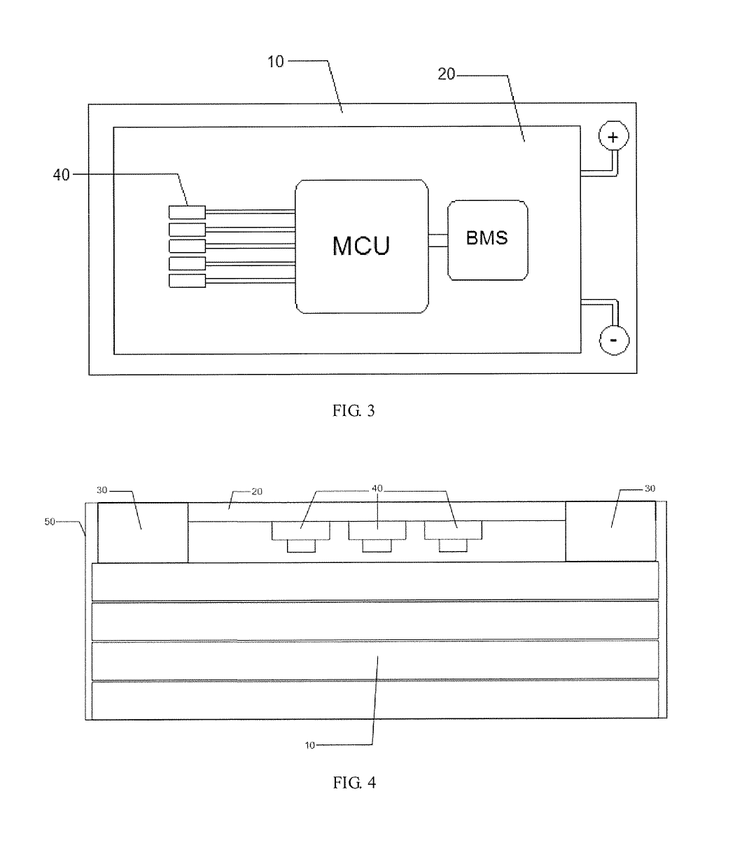

The circuit board 20 described in this embodiment is a control circuit board, as shown in FIG. 3, the circuit board 20 is provided with a micro-controller, that is, an MCU. The circuit board 20 and the sensor module 40 described in this embodiment may be combined together according to the product design requirements or may be connected by means of a circuit cable.

As shown in FIGS. 1 and 2, in this embodiment the sensor module 40 is mounted in the fixed base groove 30, and a certain number of precision mechanical pressure sensors or precision electronic sensors arranged in the form of a matrix are provided on the sensor module 40, that is, the sensor module 40 comprises a matrix-type precision mechanical pressure sensors and/or precision electronic sensors and may be a hybrid combination of any one or more of precision mechanical pressure sensors and precision electronic sensors; one surface of the battery module 10 is fixedly affixed to the fixed base groove 30, and the precision mechanical pressure sensors or the precision electronic sensors on the sensor module 40 in the fixed base groove 30 faces the side of the battery module 10, as shown in FIGS. 1 and 2, the fixed base groove 30 may be mounted in the battery chamber in the form of a separate module, or as shown in FIG. 4 to FIG. 6, the fixed base groove 30 may be directly provided on the battery chamber 50. One side of the battery module 10 is fixedly provided on the fixed base groove 30 and tightly connected with the fixed base groove 30 without a slit; the other side of the battery module 10 is tightly connected with the battery chamber 50 without a slit; in this case the distance between the precision mechanical pressure sensors or the precision electronic sensors and the battery module 10 is a safety buffer interval. Under normal circumstances, these matrix-type precision mechanical pressure sensors or precision electronic sensors will not be triggered; in case of any accidental situations which cause the bulge of the battery module 10, no matter whether the overall or local part squeezes these precision mechanical pressure sensors or precision electronic sensors to trigger either of them to send a trigger signal, the triggered precision mechanical pressure sensors or the precision electronic sensors will instantly send back the trigger signal to the MCU on the circuit board 20 so that the MCU can instantly turn off the charging and discharging of the battery module 10 as well as the operation of other product functions to prevent the product from continuous operation when the battery module 10 is in a damaged state so as to protect the product itself and the user's personal and property safety.

Notably, in this embodiment the sensor module 40 is provided in the battery chamber 50 and forms a protective system together with the circuit board 20; a safety buffer interval is provided between the sensor module 40 and the battery module 10, that is, the precision mechanical pressure sensors or the precision electronic sensors on the sensor module 40 are not directly in contact with the battery module 10 but are isolated by a fixed base groove 30; the purpose of such an arrangement is that neither the overall nor local morphology of a healthy battery module 10 which has a normal morphology can be in contact with any of the sensors in the matrix of the precision mechanical pressure sensors or the precision electronic sensors, and a normal thermal expansion and contraction of the battery module 10 in operation will not be in contact with any of the precision mechanical pressure sensors or the precision electronic sensors as well; in case of any abnormal deformation of the overall or local morphology of the battery module 10, the deformation value reaching or exceeding the pre-set abnormality threshold will break through the fixed base groove 30 and trigger the sensor in the sensor module 40 to send an interrupt signal, and the MCU on the circuit board 20 which receives the trigger signal will turn off the charging and discharging operation of the battery module 10 as well as other product functions of the battery module 10 so as to avoid more serious consequences and protect the product itself and the user's personal and property safety.

### Embodiment 2

As shown in FIG. 7, this embodiment also provides a method for detecting battery deformation by means of a sensor module, which is applied to a device for detecting battery deformation by means of a sensor module as described in Embodiment 1 and comprises the following steps:

Step S1: the circuit board 20 conducts real-time detection until it receives a trigger signal transmitted from at least one sensor in the sensor module 40;

Step S2: the circuit board 20 sends a stop signal to the battery module 10 to turn off the charging and discharging of the battery module 10;

Step S3: when the sensor module 40 is reset, a reset signal will be sent to the circuit board 20;

Step S4: the circuit board 20 sends a reset signal to the battery module 10 to restore the charging and discharging of the battery module 10.

In Step S1 of this embodiment, when the overall or local morphology of the battery module 10 reaches an abnormality threshold, it is determined that the battery module 10 is abnormal in morphology, and the sensor module 40 sends a trigger signal to the circuit board 20: wherein the abnormality threshold is set to X₀=h+X₁+X₂; wherein X₀ is an abnormality threshold of the overall or local morphology of the battery module 10, h is an overall height of the battery module 10, X₁ is a space buffer of thermal expansion generated in normal operation of the battery module 10, and X₂ is the squeeze key path or range required for triggering any of the sensors.

The dynamic distance variable of safety changes in the overall or local morphology of the battery module 10 is set to X. According to the above description, under normal circumstances, neither the overall nor local morphology of a healthy battery module 10 which has a normal morphology can be in contact with any of the precision mechanical pressure sensors or the precision electronic sensors on the sensor module 40, and a normal thermal expansion and contraction of the battery module 10 in operation will not be in contact with any of the precision mechanical pressure sensors or the precision electronic sensors in the sensor module 40 as well.

And in case of any accidental situations of the battery module 10, such as a bulge caused by chemical gas generated from oxidization of the internal chemical substances, the overall or local morphology of the battery module 10 which will reach or even exceed the abnormality threshold X₀ so as to contact the precision mechanical pressure sensors or the precision electronic sensors on the sensor module 40, and if any of the precision mechanical pressure sensors or the precision electronic sensors is triggered, the circuit board 20 will instantly turn off the charging or discharging of the failed battery module 10 as well as other functions of the product.

The basis for the circuit board 20 to determine whether or not the battery is normally charged and discharged is as follows: firstly, normal condition: X<X₀, the sensor array 40 is not triggered, so the battery module 10 is determined to have a healthy morphology and the product is in a normal operating state; secondly, abnormal condition: X≥X₀, the sensor array 40 is triggered, so the battery module 10 is determined to have an abnormal morphology and then the circuit board 20 turns off the charging and discharging operation of the battery module 10 as well as other functions, and the product is in an inoperative state.

The working process of the MCU in the circuit board 20 is as follows: firstly, any one of the precision mechanical pressure sensors or the precision electronic sensors on the sensor module 40 is triggered to send a trigger signal to the MCU; secondly, the MCU receives the trigger signal from the precision mechanical pressure sensors or the precision electronic sensors, and then instantly sends a stop signal to the BMS battery charging and discharging management system of the battery module 10; thirdly, the BMS battery charging and discharging management system receives the stop signal from the MCU and then instantly turns off the charging and discharging functions of the battery module 10 as well as other functions of the product; fourthly, the precision mechanical pressure sensors and the precision electronic sensors are reset and then a reset signal is sent to the MCU; fifthly, the MCU receives the reset signal of the precision mechanical pressure sensors or the precision electronic sensors, and then instantly sends the reset signal to the BMS battery charging and discharging management system; sixthly, the BMS battery charging and discharging management system restores the charging and discharging function of the battery module 10 as well as other functions of the product after receiving the reset signal from the MCU.

In this embodiment, the sensor module 40 is provided in the battery chamber 50 and forms a protective system together with the circuit board 20; in case of any abnormal deformation of the overall or local morphology of the battery module 10, the deformation value reaching or exceeding the pre-set abnormality threshold will trigger the sensor in the sensor module 40 to send an interrupt signal, and after receiving the trigger signal representing an interrupt, the MCU on the circuit board 20 will turn off the charging and discharging operation of the battery module 10 as well as other product functions of the battery module 10 so as to avoid more serious consequences and protect the product itself and the user's personal and property safety.

The foregoing are further detailed for the present invention in combination with detailed preferable embodiments, but are not intended to limit detailed embodiments of the present invention. Those skilled in this art can make a variety of simple deductions or variations without deviating from the principle of the present invention, and all these should be covered in the protection scope of the present invention.

1. A device for detecting battery deformation by means of a sensor module, the device comprising:
a battery module;
a circuit board;
a fixed base groove;
a sensor module; and
a battery chamber,
wherein the battery module, the circuit board and the fixed base groove are provided in the battery chamber, and the fixed base groove is provided in the battery chamber;
the sensor module is provided in the fixed base groove and located on one side of the fixed base groove near the battery module; wherein the battery module and the sensor module are electrically connected to the circuit board respectively.

2. The device for detecting battery deformation by means of a sensor module according to claim 1, wherein the fixed base groove is mounted in the battery chamber in the form of a separate module, or the fixed base groove is directly provided on the battery chamber.

3. The device for detecting battery deformation by means of a sensor module according to claim 1, wherein the sensor module is located above the battery module.

4. The device for detecting battery deformation by means of a sensor module according to claim 1, wherein the fixed base groove is a ditch-shaped or square groove.

5. The device for detecting battery deformation by means of a sensor module according to claim 1, wherein the circuit board comprises an MCU.

6. The device for detecting battery deformation by means of a sensor module according to claim 1, wherein one side of the battery module is fixedly provided on the fixed base groove and connected with the fixed base groove; the other side of the battery module is connected with the battery chamber.

7. The device for detecting battery deformation by means of a sensor module according to claim 1, wherein the sensor module comprises horizontally-distributed and longitudinally-distributed dot matrix sensors.

8. A method for detecting battery deformation by means of a sensor module, that the method for detecting battery deformation by means of a sensor module is applied to the device for detecting battery deformation by means of a sensor module as claimed in claim 1 and comprises the following steps:
Step S1: the circuit board conducts real-time detection until a trigger signal transmitted from at least one sensor in the sensor module is received;
Step S2: the circuit board sends a stop signal to the battery module to turn off a charging and discharging of the battery module;
Step S3: when the sensor module is reset, a reset signal will be sent to the circuit board;
Step S4: the circuit board sends a reset signal to the battery module to restore the charging and discharging of the battery module.

9. The method for detecting battery deformation by means of a sensor module according to claim 8, wherein in Step S1, when the overall or local morphology of the battery module reaches an abnormality threshold, the battery module is determined to be abnormal in morphology, and the sensor module sends a trigger signal to the circuit board.

10. The method for detecting battery deformation by means of a sensor module according to claim 9, wherein the abnormality threshold is set to X₀=h+X₁+X₂, wherein X₀ is an abnormality threshold of the overall or local morphology of the battery module, h is an overall height of the battery module, X₁ is a space buffer of thermal expansion generated in normal operation of the battery module, and X₂ is the squeeze key path or range required for triggering any of the sensors.

11. The device for detecting battery deformation by means of a sensor module according to claim 2, wherein the fixed base groove is a ditch-shaped or square groove.

12. The device for detecting battery deformation by means of a sensor module according to claim 3, wherein the fixed base groove is a ditch-shaped or square groove.

13. The device for detecting battery deformation by means of a sensor module according to claim 2, wherein the circuit board comprises an MCU.

14. The device for detecting battery deformation by means of a sensor module according to claim 3, wherein the circuit board comprises an MCU.

15. The device for detecting battery deformation by means of a sensor module according to claim 2, wherein one side of the battery module is fixedly provided on the fixed base groove and connected with the fixed base groove; the other side of the battery module is connected with the battery chamber.

16. The device for detecting battery deformation by means of a sensor module according to claim 3, wherein one side of the battery module is fixedly provided on the fixed base groove and connected with the fixed base groove; the other side of the battery module is connected with the battery chamber.

17. The device for detecting battery deformation by means of a sensor module according to claim 2, wherein the sensor module comprises horizontally-distributed and longitudinally-distributed dot matrix sensors.

18. The device for detecting battery deformation by means of a sensor module according to claim 3, wherein the sensor module comprises horizontally-distributed and longitudinally-distributed dot matrix sensors.

19. A method for detecting battery deformation by means of a sensor module, the method for detecting battery deformation by means of a sensor module is applied to the device for detecting battery deformation by means of a sensor module as claimed in claim 2 and comprises the following steps:
Step S1: the circuit board conducts real-time detection until a trigger signal transmitted from at least one sensor in the sensor module is received;
Step S2: the circuit board sends a stop signal to the battery module to turn off a charging and discharging of the battery module;
Step S3: when the sensor module is reset, a reset signal will be sent to the circuit board;
Step S4: the circuit board sends a reset signal to the battery module to restore the charging and discharging of the battery module.

20. A method for detecting battery deformation by means of a sensor module, the method for detecting battery deformation by means of a sensor module is applied to the device for detecting battery deformation by means of a sensor module as claimed in claim 3 and comprises the following steps:
Step S1: the circuit board conducts real-time detection until a trigger signal transmitted from at least one sensor in the sensor module is received;
Step S2: the circuit board sends a stop signal to the battery module to turn off a charging and discharging of the battery module;
Step S3: when the sensor module is reset, a reset signal will be sent to the circuit board;
Step S4: the circuit board sends a reset signal to the battery module to restore the charging and discharging of the battery module.
